(19) United States
(12) Patent Application Publication
(10) Pub. No.: US 2026/0131687 A1
(43) Pub. Date: May 14, 2026

(54) PARKING MANAGEMENT SERVER AND METHOD THEREOF

(71) Applicants: HYUNDAI MOTOR COMPANY, SEOUL (KR); KIA CORPORATION, SEOUL (KR)

(72) Inventors: Bum Sun Shin, Hwaseong-si (KR); Do Geun Jung, Hwaseong-si (KR)

(73) Assignees: HYUNDAI MOTOR COMPANY, SEOUL (KR); KIA CORPORATION, SEOUL (KR)

(21) Appl. No.: 19/328,571

(22) Filed: Sep. 15, 2025

(30) Foreign Application Priority Data
Nov. 13, 2024 (KR) 10-2024-0160728

(51) Int. Cl. B60L 53/66; G07C 5/02

(52) U.S. Cl. CPC B60L 53/66; G07C 5/02

(57) ABSTRACT

A parking management server includes a processor and a memory storing one or more programs executed by the processor, and the processor may determine whether a vehicle is parked, sets an available parking time related to a charging output of the vehicle, count an elapsed parking time by considering the time when the vehicle is parked for electric charging, and selectively provide a vehicle movement recommendation service to a user of the vehicle based on the available parking time, the elapsed parking time, and a signal for determining whether the vehicle moves.

### CROSS REFERENCE TO RELATED APPLICATIONS

This application claims priority to and the benefit of Korean Patent Application No. 10-2024-0160728, filed on November 13, 2024, the disclosure of which is incorporated herein by reference in its entirety.

### BACKGROUND

### 1. Field

The present disclosure relates to a parking management server and method thereof, and more specifically, to a parking management server and method for preventing charging obstruction in advance during charging.

### 2. Discussion of Related Art

As the spread of environmentally friendly vehicles such as electric vehicles (EV) or plug-in hybrid electric vehicles (PHEV) expands, the shortage of charging infrastructure is becoming more prominent. One of the phenomena of the shortage of charging infrastructure may include many users parking at charging stations for long periods of time, even after the users have finished charging, thereby blocking other users’ charging opportunities.

Accordingly, a law has been recently enacted to establish standards for blocking the charging of electric vehicles and impose fines for charging obstruction. For example, in the case of fast charging facilities, when a user parks for more than one hour, it is considered charging obstruction and a fine is imposed.

However, measures or services to prevent the imposition of a fine due to such charging obstruction are insufficient. Therefore, a service is needed to effectively manage charging obstruction and prevent fines from being imposed on users.

### SUMMARY

The present disclosure is directed to providing a parking management server and method that can prevent charging obstruction by determining a total parking time including the parking time and charging time and whether a vehicle moves.

The technical problems intended to be achieved in the present disclosure are not limited to the technical problems mentioned above, and other technical problems not mentioned will be clearly understood by a person having ordinary skill in the technical field to which the present disclosure belongs from the description below.

According to an aspect of the present disclosure, there is provided a parking management server including a processor and a memory storing one or more programs executed by the processor, in which the processor determines whether a vehicle is parked, sets an available parking time related to a charging output of the vehicle, counts an elapsed parking time by considering the time when the vehicle is parked for electric charging, and selectively provides a vehicle movement recommendation service to a user of the vehicle based on the available parking time, the elapsed parking time, and a signal for determining whether the vehicle moves (hereinafter referred to as a “movement determination signal”).

The processor may set the available parking time after determining whether the vehicle is parked for electric charging.

The processor may collect a first movement determination signal sensed for the first time after parking the vehicle from the vehicle when the vehicle is parked, collect a second movement determination signal sensed for the first time along with charging of the vehicle from the vehicle when the vehicle is charged, and determine that the vehicle is parked for electric charging when the first movement determination signal and the second movement determination signal are the same.

The processor may determine the time at which the first movement determination signal is sensed as the time at which the vehicle is parked when it is determined that the vehicle is parked for electric charging and may count the elapsed parking time based on the time at which the vehicle is parked.

The first and second movement determination signals are signals sensed by one of an odometer and a global positioning system (GPS) of the vehicle.

The processor may collect a third movement determination signal sensed at a point in time when the elapsed parking time reaches the available parking time, and perform processing so that the vehicle movement recommendation service is provided when a difference between the second movement determination signal and the third movement determination signal is less than or equal to a preset threshold value, and the third movement determination signal is a signal sensed at a point in time closest to the point in time when the available parking time is reached.

The processor may determine that the vehicle has moved when the difference between the second movement determination signal and the third movement determination signal is greater than the preset threshold and perform processing so that the vehicle movement recommendation service is not provided.

The processor may wake up the vehicle and then re-request the vehicle to collect the third movement determination signal when the elapsed parking time reaches the available parking time and it is confirmed that the vehicle has entered a sleep mode as a result of the third movement determination signal being requested from the vehicle.

The processor may provide the service to the user of the vehicle to prevent charging obstruction due to long-term parking of the vehicle.

According to another aspect of the present disclosure, there is provided a parking management method of a server including a processor and a memory storing one or more programs executed by the processor, the method including an operation of setting an available parking time related to a charging output of a vehicle, an operation of counting an elapsed parking time by considering the time when the vehicle is parked for electric charging, and an operation of selectively providing a vehicle movement recommendation service to a user of the vehicle based on the available parking time, the elapsed parking time, and a signal for determining whether the vehicle moves (hereinafter referred to as a “movement determination signal”).

The parking management method may further include an operation of determining whether the vehicle is parked for electric charging before the operation of setting the available parking time.

In the operation of determining whether the vehicle is parked for electric charging, when the vehicle is parked, a first movement determination signal sensed for the first time after parking the vehicle may be collected from the vehicle, when the vehicle is charged, a second movement determination signal sensed for the first time along with charging of the vehicle may be collected from the vehicle, and it may be determined that the vehicle is parked for electric charging when the first movement determination signal and the second movement determination signal are the same.

In the operation of counting the elapsed parking time, the time at which the first movement determination signal is sensed may be determined as the time at which the vehicle is parked when it is determined that the vehicle is parked for electric charging, and the elapsed parking time may be counted based on the time at which the vehicle is parked.

In the operation of selectively providing the vehicle movement recommendation service, a third movement determination signal sensed at a point in time when the available parking time is reached may be collected when the elapsed parking time reaches the available parking time, the vehicle movement recommendation service may be provided when a difference between the second movement determination signal and the third movement determination signal is less than or equal to a preset threshold value, and the third movement determination signal is a signal sensed at a point in time closest to the point in time when the available parking time is reached.

In the operation of selectively providing the vehicle movement recommendation service, it may be determined that the vehicle has moved when the difference between the second movement determination signal and the third movement determination signal is greater than the preset threshold, and the vehicle movement recommendation service is not provided.

In the operation of selectively providing the vehicle movement recommendation service, the vehicle may be woken up and then the vehicle may be re-requested to collect the third movement determination signal when the elapsed parking time reaches the available parking time and it is confirmed that the vehicle has entered a sleep mode as a result of the third movement determination signal being requested from the vehicle.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings, in which:

FIG. 1 is a diagram illustrating an electric vehicle parking management system according to an embodiment of the present disclosure;

FIG. 2 is an exemplary diagram illustrating a situation in which an electric vehicle is parked in a first parking area of electric vehicle supply equipment (EVSE) for charging;

FIG. 3 is a block diagram illustrating an electric vehicle according to an embodiment of the present disclosure;

FIG. 4 is a block diagram illustrating a parking management server according to an embodiment of the present disclosure;

FIG. 5 is a flowchart illustrating the operation of an electric vehicle in a parking management method according to an embodiment of the present disclosure;

FIG. 6 is a flowchart illustrating the operation of a parking management server in the parking management methods according to an embodiment of the present disclosure; and

FIG. 7 is a flowchart illustrating operation S640 of FIG. 6 in detail.

### DETAILED DESCRIPTION

Hereinafter, embodiments of the present disclosure will be described in detail with reference to the accompanying drawings so that those skilled in the art may easily carry out the embodiments. However, the present disclosure may be implemented in various different forms and is not limited to the embodiments described herein.

In describing embodiments of the present disclosure, when it is determined that a specific description of a known configuration or function may obscure the gist of the present disclosure, a detailed description thereof will be omitted. In addition, parts unrelated to the description of the present disclosure in the drawings have been omitted, and similar parts have been given similar reference numerals.

In the present disclosure, when a component is said to be “connected,” “coupled,” or “joined” to another component, this may include not only a direct connection relationship, but also an indirect connection relationship in which another component is present therebetween. In addition, when a component is referred to as “including” or “having” another component, this does not mean that other components are excluded but may rather other components may be included unless specifically stated to the contrary.

In the present disclosure, the terms first, second, etc. are used only for the purpose of distinguishing one component from another component, and do not limit the order or importance of the components unless specifically stated otherwise. Therefore, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe the characteristics of each component, and do not necessarily mean that the components are separated. That is, a plurality of components may be integrated to form a single hardware or software unit, or a single component may be broken up to form a plurality of hardware or software units. Accordingly, even if not mentioned separately, embodiments in which a plurality of components are integrated or a single component is broken up is also included in the scope of the present disclosure.

In the present disclosure, the components described in various embodiments do not necessarily mean essential components, and some components may be optional components. Therefore, an embodiment composed of a subset of components described in an embodiment is also included in the scope of the present disclosure. In addition, embodiments that include other components in addition to the components described in various embodiments are also included in the scope of the present disclosure.

In the present disclosure, each of the phrases such as “A or B,” “at least one of A and B,” “at least one of A or B,” “A, B or C,” “at least one of A, B and C,” and “at least one of A, B, C or combination thereof” may include any one of the items listed together with the corresponding phrase among the phrases, or all possible combinations thereof.

The advantages and features of the present disclosure, and the methods for achieving them will become clearer with reference to the embodiments described in detail below together with the accompanying drawings. However, the present disclosure is not limited to embodiments presented below, but may be implemented in various different forms, and the embodiments are provided only to make the disclosure of the present disclosure complete and to fully inform a person having ordinary skill in the art to which the present disclosure belongs of the scope of the disclosure.

In addition, the terms “module,” “unit,” “device,” “server,” etc. in this specification may also be intended to refer to hardware or a functional or structural combination of software driven by or for driving hardware. For example, the hardware herein may be a data processing device including a central processing unit (CPU) or another first processor. In addition, the software driven by the hardware may refer to a process, an object, an executable, a thread of execution, a program, etc. that are being executed.

In the present disclosure, a “system” may include one or more computing devices, and may be provided in a local or cloud form, but is not limited thereto.

Hereinafter, specific technical content to be implemented in the present disclosure will be described in detail with reference to the accompanying drawings.

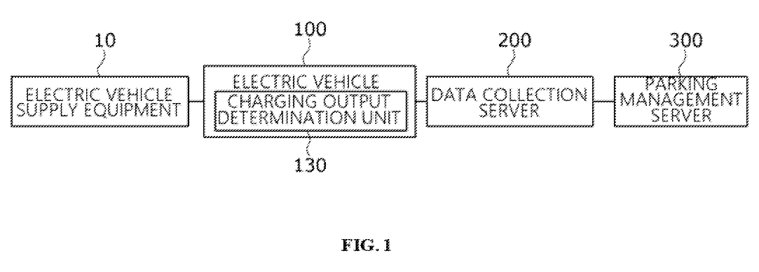

FIG. 1 is a diagram illustrating an electric vehicle parking management system according to an embodiment of the present disclosure.

Referring to FIG. 1, the electric vehicle parking management system according to the embodiment of the present disclosure may include an electric vehicle 100, a data collection server 200, and a parking management server 300.

The electric vehicle 100 is a vehicle equipped with a battery and driving wheels using electricity charged in the battery. The electric vehicle 100 includes an electric vehicle (EV) and a plug-in hybrid electric vehicle (PHEV).

The electric vehicle 100 receives electricity from electric vehicle supply equipment (EVSE) 10 through a cable to charge the battery. The cable is connected to the EVSE 10 and a connector 110 of the electric vehicle 100. A user of the electric vehicle 100 may select a charging type, that is, a charging output, from the EVSE 10. The user may select fast charging or standard charging as the charging output.

Fast charging is, for example, performed using a direct current (DC) charging method and power input to the electric vehicle 100 is higher than that of standard charging. For example, during fast charging, power is transmitted at 40 kW or more, and the charging of the electric vehicle 100 may be completed within 1 hour.

Standard charging is, for example, performed using an alternating current (AC) charging method, and the charging of the electric vehicle 100 may take 10 hours or more.

Since the user starts charging after parking near the EVSE 10, the electric vehicle 100 remains in a parked state while charging. In this case, the user may unintentionally maintain the parked state of the vehicle even after charging is completed, and this may block the charging of other vehicles.

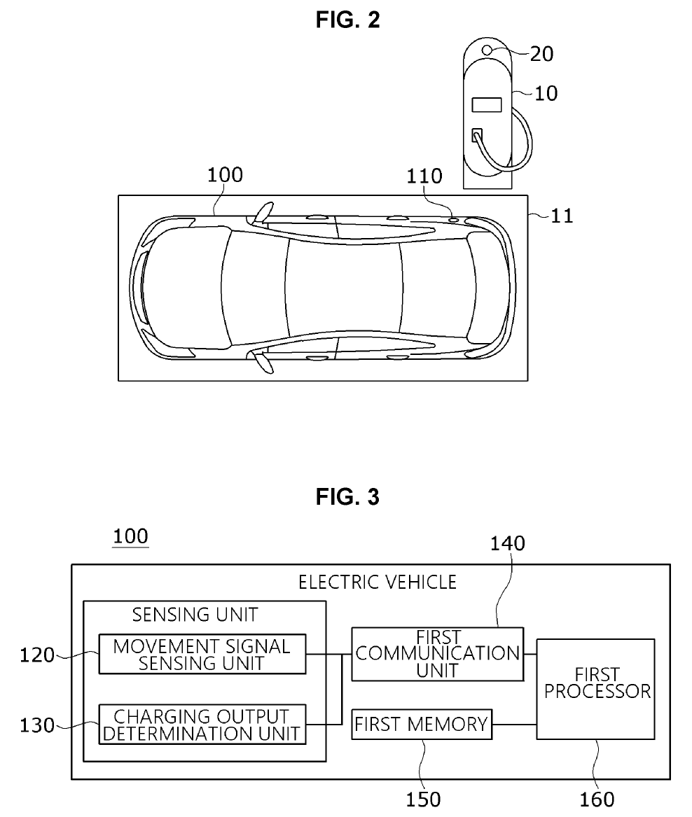

FIG. 2 is an exemplary diagram illustrating a situation in which the electric vehicle 100 is parked in a first parking area 11 of the EVSE 10 for charging.

Referring to FIG. 2, a user may park the electric vehicle 100 in the first parking area 11, make payment, and then connect the cable to the connector 110. Alternatively, in contrast, the user may first connect the cable and then make payment. In this case, there may be cases where the user needs to change a parking position. For example, there are various cases where the parking location needs to be changed, such as, when the cable does not reach the connector 110, when the connector 110 is connected but charging does not occur due to a defect in the connector 110, or when payment is not processed normally, or when the user needs to move in a hurry, etc.

Referring back to FIG. 1, when charging is possible, the EVSE 10 supplies power according to a set charging output. For example, when the EVSE 10 is a fast charger, the EVSE 10 may supply power at 40 kW or more, and when the EVSE 10 is a standard charger, the EVSE 10 may supply power at less than 40 kW. 40 kW is an example and the set charging output is not limited thereto.

In addition, the EVSE 10 is physically ready to supply power when the cable is connected to the connector 110, and in this case, the EVSE 10 may form a communication channel with the electric vehicle 100 and transmit charging information using a communication protocol. The charging information may include charging power amount, voltage, current, and charging type (i.e., DC or AC). The communication protocol may follow standards such as the International Organization for Standardization (ISO) 15118, or may include, but is not limited to, protocols such as Combined Charging System (CCS), CHArge de MOve (CHAdeMO), and Guobiao/Technical Specification (GB/T).

In addition, payment information may be transmitted to the parking management server 300 through a separate channel. The parking management server 300 may again transmit payment information to the user's electronic terminal (not illustrated) to notify the user.

In addition, a camera 20 installed in or near the EVSE 10 may capture the first parking area 11 including the electric vehicle 100 and transmit the captured image generated by capturing to a parking monitoring server (not illustrated).

The parking monitoring server (not illustrated) analyzes the captured image and counts the total parking time during which the electric vehicle 100 has been parked in the first parking area 11. The parking monitoring server (not illustrated) may determine that charging obstruction (or charging obstruction) has occurred when the total parking time reaches the maximum parking time set by law, and impose a fine. For example, for fast charging, the maximum parking time may be set to 1 hour, and for standard charging, the maximum parking time may be set to 14 hours.

The electric vehicle 100 may transmit information necessary for managing the parking time of the electric vehicle 100, such as a first movement determination signal sensed after parking in the first parking area 11, parking time information, a second movement determination signal sensed when charging starts, charging start time information, and charging output information, to the data collection server 200.

FIG. 3 is a block diagram illustrating the electric vehicle 100 according to the embodiment of the present disclosure.

Referring to FIGS. 1 to 3, the electric vehicle 100 according to the embodiment of the present disclosure may include the connector 110, a movement signal sensing unit 120, a charging output determination unit 130, a first communication unit 140, a first memory 150, and a first processor 160.

The connector 110 may be connected to a cable of the EVSE 10 to receive power and supply the input power to a battery.

The movement signal sensing unit 120 may sense a signal for determining whether the electric vehicle 100 moves, i.e., a movement determination signal, periodically or in real time, and transmit the sensed movement determination signal to the charging output determination unit 130. The movement determination signal sensed by the movement signal sensing unit 120 may include first to third movement determination signals to be described below.

The movement signal sensing unit 120 may include, for example, an odometer or a global positioning system (GPS) module. The odometer senses and provides a traveling distance of the electric vehicle 100, and the GPS module provides current location information of the electric vehicle 100.

The charging output determination unit 130 may determine the charging output of the power (or charging power) input from the electric charger 10 to the connector 110. When the charging output increases, the charging speed becomes faster, and fast charging and standard charging may be distinguished depending on the charging output. For example, the charging output determination unit 130 may be an on-board charger (OBC) or a battery management system (BMS).

The first communication unit 140 may form a communication channel with the EVSE 10, receive the charging information through the communication channel, and transmit the received charging information to the first processor 160.

In addition, the first communication unit 140 may transmit the movement determination signal sensed by the movement signal sensing unit 120 and the charging output determined by the charging output determination unit 130 to the first processor 160, and transmit first parking management information to third parking management information stored in the first memory 150 to the parking management server 300.

In addition, the first communication unit 140 may transmit payment information received from the parking management server 300 to the first processor 160.

The first parking management information may include the first movement determination signal and information on the time at which the electric vehicle 100 started parking. The information on the time at which the electric vehicle 100 started parking may be information on the time at which the first movement determination signal is sensed. The second parking management information may include a second movement determination signal, information on the time at which the second movement determination signal is sensed, and charging output information (fast charging or standard charging). The third parking management information may include a third movement determination signal sensed after the second movement determination signal is sensed, and information on the time at which the third movement determination signal is sensed.

The first communication unit 140 may perform wired communication to transmit and receive data, signals, etc. through controller area network (CAN) communication or Ethernet communication.

In addition, the first communication unit 140 may include a communication module that communicates with the data collection server 200 through a wired or wireless communication network. The wired or wireless communication network may include wireless LAN (WLAN), wireless broadband (Wibro), Wi-Fi, World Interoperability for Microwave Access (Wimax), high speed downlink packet access (HSDPA), code division multi access (CDMA), enhanced voice-data optimized or enhanced voice-data only (EV-DO), wideband CDMA (WCDMA), high speed downlink packet access (HSDPA), high speed uplink packet access (HSUPA), 3G 4G such as long term evolution (LTE) or 5G communication networks.

The first memory 150 may store a plurality of instructions or a program including instructions necessary to execute the operation of the electric vehicle 100 or the first processor 160. The first memory 150 may include at least one of storage media such as a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage. In addition, the first memory 150 may include a database (DB).

In addition, the first memory 150 may store a plurality of movement determination signals sensed in real time by the movement signal sensing unit 120, information on the time at which the movement determination signals are sensed, a charging output sensed by the charging output determination unit 130, and charging information received from the electric charger 10. The charging information may include charging power amount, voltage, current, and charging type (i.e., DC or AC).

The first processor 160 may control or process the operation of the electric vehicle 100 by executing instructions or programs stored in the first memory 150. The first processor 160 may include at least one of processing devices such as an application specific integrated circuit (ASIC), a digital signal processor (DSP), a programmable logic device (PLD), a field programmable gate array (FPGA), a central processing unit (CPU), a microcontroller, and/or a microprocessor.

For example, when a fast charging event or standard charging event is detected, the first processor 160 may perform processing so that a movement determination signal is transmitted to the data collection server 200 through the first communication unit 140.

The first processor 160 may determine whether the electric vehicle 100 is parked. The first processor 160 may determine whether the electric vehicle 100 is parked by considering at least one of a transmission mode, a start mode, and payment information of the electric vehicle 100. The transmission mode may include a parking mode, a neutral mode, a reverse mode, and a low mode. The start mode may include Accessory Off (ACC Off), Accessory On (ACC On), Key ON, and EV Ready. ACC Off refers to a state in which all of the vehicle's auxiliary devices or electronic devices are turned off, and means a state before starting the engine or changing to the ACC On with vehicle's power completely turned off. ACC On refers to a state in which the vehicle's power is partially turned on and electronic devices such as the radio or navigation may operate. Key ON refers to a state just before the key is turned to start the vehicle, in which all electronic devices and the instrument panel are turned on. In vehicles with a start button, Key ON may refer to a stage before the power is turned on by pressing the key. EV Ready refers to a state in which an electric vehicle or hybrid vehicle is ready to drive with a motor. For example, EV Ready may refer to a state in which the vehicle may start driving with an electric motor rather than an engine.

The payment information may include information on the time at which payment is completed and identification information of the EVSE 10 for which payment is made.

For example, when the electric vehicle 100 can be charged only when the engine is turned off, the first processor 160 may determine that the electric vehicle 100 is parked when the transmission is in a parking mode and the start mode of the electric vehicle 100 is ACC Off.

Alternatively, when the electric vehicle 100 can be charged even when the engine is turned on, the first processor 160 may determine that the electric vehicle 100 is parked when the transmission is in the parking mode and the start mode of the electric vehicle 100 is ACC Off.

Alternatively, when the electric vehicle 100 can be charged even when the engine is turned on, the first processor 160 may determine that the electric vehicle 100 is parked when the transmission is in parking mode and an idle state is maintained for a predetermined time or more. The idle state is a state in which power is supplied to the motor of the electric vehicle 100 in the parking mode. The idle state may be a state similar to idling of an internal combustion engine vehicle.

Alternatively, the first processor 160 may determine that the electric vehicle 100 is parked when payment information is received from the parking management server 300 or when the charging information received from the electric charger 10 includes information indicating payment completion. In this case, the first processor 160 may determine that the electric vehicle 100 is not yet parked when payment is made while the engine is turned on, and may determine that the vehicle is parked when the engine is turned off thereafter.

In addition, the first processor 160 may determine whether the vehicle is parked based on the condition that is achieved first among the conditions described above.

When it is determined that the electric vehicle 100 is parked, the first processor 160 confirms and collects the first movement determination signal sensed for the first time after parking and the time at which the first movement determination signal is sensed in the first memory 150 to generate the first parking management information. The first processor 160 may control the first communication unit 140 to transmit the generated first parking management information to the data collection server 200 each time the first parking management information is generated. The time at which the first movement determination signal is sensed may be used as the time at which the electric vehicle 100 is parked by the parking management server 300.

When the user moves the electric vehicle 100 before starting charging, the first processor 160 may re-determine whether the electric vehicle 100 is parked, generate new first parking management information, and then transmit the new first parking management information to the data collection server 200. An example of the user moving the electric vehicle 100 has been described with reference to FIG. 2, and the user may change the parking location of the electric vehicle 100 more than once for charging. Therefore, the electric vehicle 100 may generate new first parking management information each time new parking occurs and transmit the new first parking management information to the data collection server 200. Even when charging is complete and the electric vehicle 100 moves, the first processor 160 may generate and transmit the first parking management information.

Thereafter, when charging starts, the first processor 160 confirms and collects the second movement determination signal sensed for the first time along with charging, information on the time at which the second movement determination signal is sensed, and the charging output information in the first memory 150 to generate second parking management information. The first processor 160 controls the first communication unit 140 to transmit the generated second parking management information to the data collection server 200. The information on the time at which the second movement determination signal is sensed may be used by the parking management server 300 as the time at which the electric vehicle 100 started charging.

For example, the first processor 160 may determine a point in time when charging started from a battery management system (BMS) that monitors a state of the battery being charged. Therefore, the first processor 160 may determine a movement determination signal sensed at the same time as the time at which charging started or at a point in time with the smallest deviation as the second movement determination signal.

In addition, the first processor 160 may sense the third movement determination signal at the request of the parking management server 300, generate third parking management information including the third movement determination signal and information on the time at which the third movement determination signal is sensed, and control the first communication unit 140 to transmit the third parking management information to the data collection server 200.

When the first processor 160 is in a sleep mode and cannot sense the third movement determination signal, the parking management server 300 may also use a fourth movement determination signal most recently stored in the data collection server 200 as the third movement determination signal.

Referring back to FIG. 1, the data collection server 200 may receive and store the first parking management information to third parking management information from the electric vehicle 100, and transmit the same to the parking management server 300. The data collection server 200 may be a database management system (DBMS) that provides a data collection platform. Since first parking management information P1 is generated each time the electric vehicle 100 is parked, the first parking management information P1 may be received multiple times within a short period of time (for example, within 1 hour).

The data collection server 200 may collect the first parking management information to third parking management information, that is, a plurality of pieces of time information and a plurality of movement determination signals necessary to prevent charging obstruction when the electric vehicle 100 is parked, when the charging output is determined, and when the available parking time arrives, and transmit the plurality of pieces of time information and the plurality of movement determination signals to the parking management server 300, based on Ethernet communication.

The data collection server 200 and the parking management server 300 may be integrally implemented as a single device.

The parking management server 300 may set the available parking time related to the electric charging output of the electric vehicle 100 and count the elapsed parking time by considering the time at which the electric vehicle 100 is parked for electric charging. In addition, the parking management server 300 may selectively provide a vehicle movement recommendation service to the user of the electric vehicle 100 based on the set available parking time, the elapsed parking time, and the signal for determining whether the electric vehicle 100 moves (hereinafter referred to as a ‘movement determination signal’). The movement determination signal is a signal for determining whether the electric vehicle 100 has moved from the first parking area 11 to another location. The vehicle movement recommendation service is a service that notifies users to move the electric vehicle 100 to another location.

When the electric vehicle 100 is a vehicle subscribed to a connected car service, the parking management server 300 may be a server that provides the connected car service.

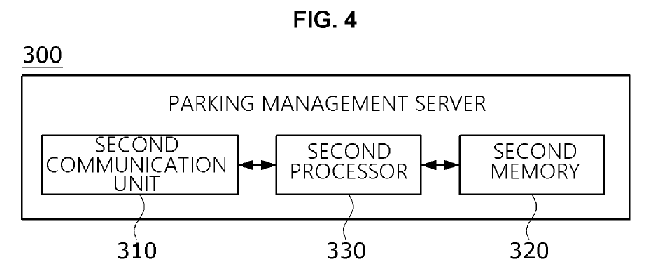

FIG. 4 is a block diagram illustrating the parking management server 300 according to an embodiment of the present disclosure.

Referring to FIG. 4, the parking management server 300 according to the embodiment of the present disclosure may include a second communication unit 310, a second memory 320, and a second processor 330.

The second communication unit 310 may individually receive the first parking management information to third parking management information from the data collection server 200. The second communication unit 310 may request transmission of the third movement determination signal from or transmit a wake-up command to the electric vehicle 100. The second communication unit 310 may provide a communication module for communicating with the data collection server 200 through a wired or wireless communication network.

Since the second memory 320 may store at least one program (for example, an operating system, software, firmware, middleware, or application, etc.), various types of data, and at least one instruction for controlling the parking management server 300, at the request of the second processor 330, a program may be loaded therefrom, data may be read or written therefrom or thereto, or an operation corresponding to an instruction may be performed. The second memory 320 may include a volatile memory and a nonvolatile memory.

For example, the second memory 320 may store the first parking management information to third parking management information and a program for providing a service of preventing charging obstruction.

The second processor 330 may perform overall control of the parking management server 300 according to an input instruction. For example, the second processor 330 may execute the program or instruction stored in the second memory 320 to control the operation of other components (hardware or software) connected to the parking management server 300 and perform data processing and computation.

The second processor 330 may set the available parking time related to the charging output of the electric vehicle 100, count the elapsed parking time by considering the time when the electric vehicle 100 is parked for charging, and selectively provide a vehicle movement recommendation service to the user based on the available parking time, the elapsed parking time, and a plurality of movement determination signals.

In detail, the second processor 330 may store the first parking management information to third parking management information received at time intervals from the data collection server 200 in the second memory 320.

Then, the second processor 330 compares the first movement determination signal included in the first parking management information with the second movement determination signal included in the second parking management information. When the first movement determination signal and the second movement determination signal are different, the second processor 330 may determine that the electric vehicle 100 is not parked for charging and wait until new first parking management information is received again.

When the first movement determination signal of the new first parking management information received again and the second movement determination signal are the same, the second processor 330 may determine that the electric vehicle 100 is parked for charging. In addition, since it is determined that the electric vehicle 100 is parked for charging, the second processor 330 may set the time at which the new first movement determination signal is sensed as the time at which the electric vehicle 100 is parked, and count the elapsed parking time based on the time at which the electric vehicle 100 is parked. That is, the second processor 330 counts the elapsed parking time based on the time at which the electric vehicle 100 is last parked, not the time at which charging starts, thereby allowing for more effective prevention of charging obstruction by considering the time used for parking.

In addition, the second processor 330 may confirm the charging output information included in the second parking management information, and set the available parking time related to the confirmed charging output information. The second processor 330 may determine the charging type (distinguish between fast charging and standard charging according to the charging power) to distinguish the type of charging facility where the electric vehicle 100 is parked (fast charging facility or standard charging facility), and set the available parking time according to the charging type. That is, the second processor 330 may set the available parking time related to the charging output.

For example, when the charging output information is fast charging, the second processor 330 may set a time less than the maximum parking time (for example, 1 hour) stipulated by law as the available parking time (for example, 50 minutes). In addition, when the charging output information is standard charging, the second processor 330 may set a time less than the maximum parking time (for example, 14 hours) stipulated by law as the available parking time (for example, 13.5 hours).

The available parking time may be changed by a manager of the parking management server 300 or the user of the electric vehicle 100 by operating the electric vehicle 100 or the user's electronic terminal. When there is no request from the user of the electric vehicle 100, the second processor 330 may set a default value determined in advance for each charging output as the available parking time.

When the counted elapsed parking time reaches the available parking time, the second processor 330 may confirm the third movement determination signal sensed after the current point in time when the available parking time is reached. For example, the second processor 330 may request the third movement determination signal sensed most recently based on the current point in time while transmitting the current point in time to the electric vehicle 100.

The second processor 330 may determine that the electric vehicle 100 is parked in the first parking area 11 when an absolute value of a difference between the second movement determination signal and the third movement determination signal (hereinafter referred to as “deviation”) is less than or equal to a preset threshold value, and perform processing so that a vehicle movement recommendation service is provided to the user of the electric vehicle 100. For example, the second processor 330 may provide a service in the form of a text message, a pop-up window, notification, etc. by using information on the user’s electronic terminal (not illustrated). The user's electronic terminal is a device capable of wired/wireless communication, such as a user's smart phone, tablet PC, or wearable terminal, and may set functions provided by the electric vehicle 100 or the parking management server 300.

In addition, the second processor 330 may determine that the electric vehicle 100 has moved out of the first parking area 11 when the calculated deviation is greater than a preset threshold value, and may perform processing so that the vehicle movement recommendation service is not provided.

Meanwhile, the second processor 330 may wake up the electric vehicle 100 and then re-request the electric vehicle 100 to collect the third movement determination signal when the elapsed parking time reaches the available parking time and it is determined that the electric vehicle 100 has entered a sleep mode as a result of the third movement determination signal being requested from the electric vehicle 100. For example, the second processor 330 may control the electric vehicle 100 to wake up by transmitting a text message to the electric vehicle 100.

Alternatively, when it is determined that the electric vehicle 100 is in the sleep mode, the second processor 330 may determine whether the electric vehicle 100 has moved out of the first parking area 11 by using the deviation between the first movement determination signal and the second movement determination signal at a point in time when the vehicle is last parked. The first movement determination signal at the point in time when the vehicle is last parked may be stored in the data collection server 200 or the second memory 320.

In this way, by providing the vehicle movement recommendation service to the user of the electric vehicle 100, it is possible to prevent charging obstruction due to long-term parking of the electric vehicle 100.

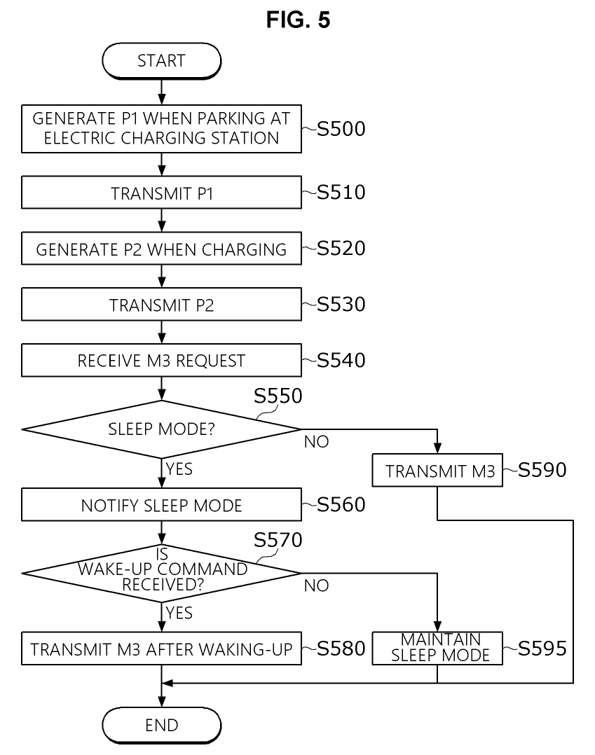

FIG. 5 is a flowchart illustrating the operation of the electric vehicle 100 in the parking management method according to the embodiment of the present disclosure.

Referring to FIG. 5, when it is determined that the electric vehicle 100 is parked in the first parking area 11 where the electric charger 10 is installed, the first movement determination signal sensed first after parking and the time at which the first movement determination signal is sensed may be collected to generate parking management information (S500). The time at which the first movement determination signal is sensed may be used as the time at which the electric vehicle 100 is parked by the parking management server 300.

The electric vehicle 100 may transmit the generated first parking management information to the data collection server 200 (S510). For example, determining whether the electric vehicle 100 is parked may be performed by confirming whether the mode of the transmission is changed to a parking mode. When the electric vehicle 100 is parked again due to a situation such as FIG. 2 or another situation, the electric vehicle 100 may perform operations S500 and S510 again.

When charging starts, the electric vehicle 100 may collect the second movement determination signal sensed initially along with the start of charging, information on the time at which the second movement determination signal is sensed, and the charging output information to generate second parking management information (S520).

The electric vehicle 100 may transmit the generated second parking management information to the data collection server 200 (S530).

Thereafter, the electric vehicle 100 receives a signal requesting transmission of the third movement determination signal from the parking management server 300 (S540).

When the electric vehicle 100 is in a sleep mode (Yes in S550), the electric vehicle 100 may notify the parking management server 300 that the electric vehicle 100 is in a sleep mode or not respond (S560).

When a wake-up command from the parking management server 300 is received (Yes in S570), the electric vehicle 100 may switch to a wake-up state and then sense a third movement determination signal and transmit the third movement determination signal to the data collection server 200 (S580).

Meanwhile, when the electric vehicle 100 is not in the sleep mode in operation S550 (No in S550), the electric vehicle 100 may sense the third movement determination signal and transmit the third movement determination signal to the data collection server 200 (S590). In operations S580 and S590, third parking management information including the third movement determination signal and information on the time at which the third movement determination signal is sensed may also be transmitted.

In addition, when the wake-up command is not received in operation S570 (No in S570), the electric vehicle 100 maintains the sleep mode (S595).

In addition, although not illustrated, after operation S520, the electric vehicle 100 may generate and transmit new first parking management information when movement occurs.

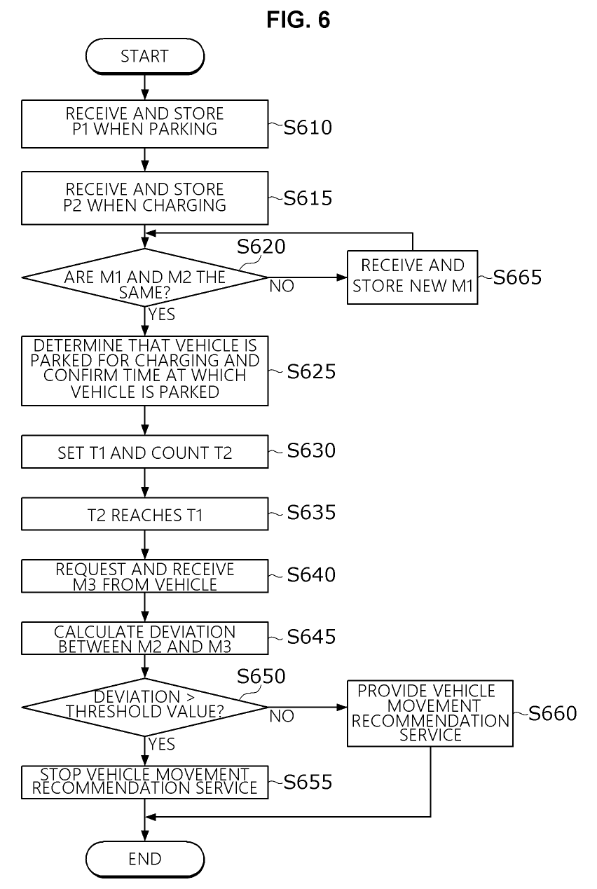

FIG. 6 is a flowchart illustrating the operation of the parking management server 300 in the parking management method according to the embodiment of the present disclosure.

Referring to FIG. 6, the parking management server 300 may receive first parking management information P1 generated when the electric vehicle 100 is parked from the data collection server 200 and store the first parking management information P1 (S610). When the electric vehicle 100 moves before charging, the parking management server 300 may receive new first parking management information P1.

In addition, the parking management server 300 may receive second parking management information P2 generated when the electric vehicle 100 is charged from the data collection server 200 and store the second parking management information P2 (S615).

The parking management server 300 may determine whether a first movement determination signal M1 of the first parking management information P1 and a second movement determination signal M2 of the second parking management information P2 are the same (S620).

When the first movement determination signal M1 and the second movement determination signal M2 of the second parking management information P2 are the same (Yes in S620), the parking management server 300 may determine that the electric vehicle 100 is parked for charging at the location corresponding to the first movement determination signal M1, and confirm the time at which the electric vehicle 100 is parked (S625). In operation S625, the time at which the first movement determination signal M1 is sensed is confirmed as the time of parking, and the time at which the first movement determination signal M1 is sensed is included in the first parking management information P1.

The parking management server 300 may count an elapsed parking time T2 based on the vehicle is parking time confirmed in operation S625, confirm the charging output information included in the second parking management information P2, and set an available parking time T1 related to the confirmed charging output information (S630). The elapsed parking time may be counted based on the time when the electric vehicle 100 is last parked, not the time at which charging starts, in operation S630, and thus the possibility of being fined due to charging obstruction may be minimized.

When the counted elapsed parking time T2 reaches the available parking time T1 (S635), the parking management server 300 requests and receives transmission of a third movement determination signal M3 from the electric vehicle 100 (S640).

The parking management server 300 calculates the deviation between the second movement determination signal M2 and the third movement determination signal M3 (S645).

When the calculated deviation is greater than the threshold value set in advance (Yes in S650), the parking management server 300 determines that the electric vehicle 100 has already moved out of the first parking area 11 and may stop the vehicle movement recommendation service (S655).

On the other hand, when the calculated deviation is less than the threshold value set in advance (No in S650), the parking management server 300 may determine that the electric vehicle 100 is still parked in the first parking area 11 and provide the vehicle movement recommendation service (S660).

In addition, when it is determined that the first movement determination signal M1 and the second movement determination signal M2 are not the same in operation S620 (No in S620), the parking management server 300 may determine that the electric vehicle 100 is in a parked state but is not parked for charging, and receive and store new first parking management information (S665). In step S665, the parking management server 300 may request the electric vehicle 100 to transmit new first parking management information, or may generate and transmit new first parking management information each time the electric vehicle 100 is parked.

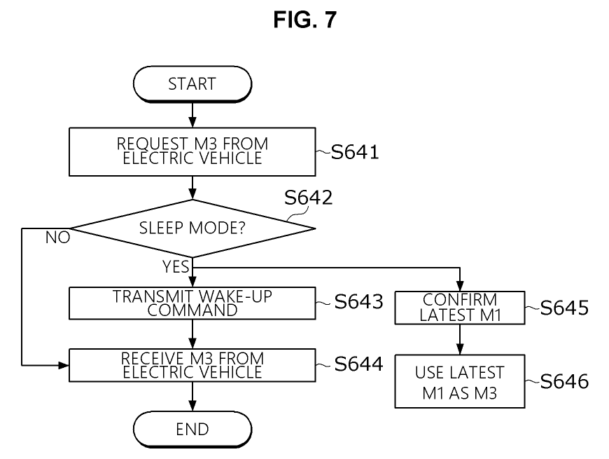

FIG. 7 is a flowchart illustrating operation S640 of FIG. 6 in detail.

Referring to FIG. 7, the parking management server 300 may request the electric vehicle 100 to transmit the third movement determination signal M3 (S641).

When a signal indicating that the electric vehicle 100 is in a sleep mode is received (Yes in S642), the parking management server 300 may transmit a wake-up command signal to the electric vehicle 100 (S643). Operation S643 may also be performed through the data collection server 200.

Thereafter, when the electric vehicle 100 enters the wake-up state, the parking management server 300 may receive the third movement determination signal M3 from the electric vehicle 100 (S644).

Alternatively, when a signal indicating that the electric vehicle 100 is in the sleep mode is received (Yes in S642), the parking management server 300 may confirm the first movement determination signal at the point in time when the vehicle is last parked in the data collection server 200 or the second memory 320 (S645) and use the confirmed first movement determination signal M1 as the third movement determination signal (M3) (S646).

Exemplary methods of the present disclosure described above are expressed as a series of operations for clarity of explanation, but this is not intended to limit the order in which steps are performed, and the steps may be performed simultaneously or in a different order, if necessary. In order to implement the method according to the present disclosure, other steps may be included in addition to the exemplified steps, some steps may be omitted and the other steps included except, or some steps may be omitted and other additional steps included.

The various embodiments of the present disclosure do not list all possible combinations, but are intended to describe representative aspects of the present disclosure, and the matters described in the various embodiments may be applied independently or in combinations of two or more.

In addition, the various embodiments of the present disclosure may be implemented by hardware, firmware, software, or a combination thereof. In the case of hardware implementation, the embodiments may be implemented by one or more application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc.

According to the present disclosure, the elapsed parking time is counted by considering the time required for parking when charging an electric vehicle, the available parking time is set by considering the charging output, and then the elapsed parking time and the available parking time are compared to determine in advance whether a situation that can be determined as charging obstruction is being encountered, and the user is notified to move the vehicle, thereby preventing payment of a fine due to charging obstruction.

The effects that can be obtained from the present disclosure are not limited to the effects mentioned above, and other effects that are not mentioned can be clearly understood by a person having ordinary knowledge in the technical field to which the present disclosure belongs from the description below.

The scope of the present disclosure includes software or machine-executable instructions (e.g., operating systems, applications, firmware, programs, etc.) that cause operations according to various embodiments of the present disclosure to be executed on a device or a computer, and a non-transitory computer-readable medium executable on a device or a computer and in which such software or instructions are stored.

1. A parking management server comprising:
a processor; and
a memory configured to store one or more programs executed by the processor;
wherein the processor is configured to:
determine whether a vehicle is parked;
set an available parking time related to a charging output of the vehicle;
count an elapsed parking time by considering the time when the vehicle is parked for electric charging; and
providing a vehicle movement recommendation service to a user of the vehicle based on the available parking time, the elapsed parking time, and a signal for determining whether the vehicle moves.

2. The parking management server of claim 1, wherein the processor is further configured to set the available parking time after determining whether the vehicle is parked for electric charging.

3. The parking management server of claim 2, wherein the processor is further configured to collect a first movement determination signal sensed for a first time after parking the vehicle, from the vehicle when the vehicle is parked, to collect a second movement determination signal sensed for a first time along with charging of the vehicle, from the vehicle when the vehicle is charged, and to determine that the vehicle is parked for electric charging when the first movement determination signal and the second movement determination signal are the same.

4. The parking management server of claim 3, wherein the processor is further configured to determine the first time at which the first movement determination signal is sensed as the time at which the vehicle is parked when it is determined that the vehicle is parked for electric charging, and to count the elapsed parking time based on the time at which the vehicle is parked.

5. The parking management server of claim 3, wherein the first and second movement determination signals are signals sensed by one of an odometer and a global positioning system (GPS) of the vehicle.

6. The parking management server of claim 3, wherein the processor is further configured to collect a third movement determination signal sensed at a point in time when the elapsed parking time reaches the available parking time, and to perform processing so that the vehicle movement recommendation service is provided when a difference between the second movement determination signal and the third movement determination signal is less than or equal to a preset threshold value; and
wherein the third movement determination signal is a signal sensed at a point in time closest to the point in time when the available parking time is reached.

7. The parking management server of claim 6, wherein the processor is further configured to determine that the vehicle has moved when the difference between the second movement determination signal and the third movement determination signal is greater than the preset threshold, and to perform processing so that the vehicle movement recommendation service is not provided.

8. The parking management server of claim 7, wherein the processor is further configured to wake up the vehicle, and then to re-request the vehicle to collect the third movement determination signal when the elapsed parking time reaches the available parking time, and it is confirmed that the vehicle has entered a sleep mode as a result of the third movement determination signal being requested from the vehicle.

9. The parking management server of claim 1, wherein the processor is further configured to provide the vehicle movement recommendation service to the user of the vehicle to prevent charging obstruction due to long-term parking of the vehicle.

10. The parking management server of claim 9, wherein the vehicle movement recommendation service comprises a notification to the user via a text message or pop-up window.

11. A parking management method of a server including a processor and a memory storing one or more programs executed by the processor, the method comprising:
setting, by the processor, an available parking time related to a charging output of a vehicle;
counting an elapsed parking time by considering the time when the vehicle is parked for electric charging; and
providing a vehicle movement recommendation service to a user of the vehicle based on the available parking time, the elapsed parking time, and a signal for determining whether the vehicle moves.

12. The parking management method of claim 11 further comprising determining whether the vehicle is parked for electric charging before the setting of the available parking time.

13. The parking management method of claim 12, wherein, in determining whether the vehicle is parked for electric charging, when the vehicle is parked, a first movement determination signal sensed for a first time after parking the vehicle is collected from the vehicle, when the vehicle is charged, a second movement determination signal sensed for a first time is collected from the vehicle, and it is determined that the vehicle is parked for electric charging when the first movement determination signal and the second movement determination signal are the same.

14. The parking management method of claim 13, wherein, in counting the elapsed parking time, the time at which the first movement determination signal is sensed is determined as the time at which the vehicle is parked when it is determined that the vehicle is parked for electric charging, and the elapsed parking time is counted based on the time at which the vehicle is parked.

15. The parking management method of claim 13, wherein the first and second movement determination signals are signals sensed by one of an odometer and a global positioning system (GPS) of the vehicle.

16. The parking management method of claim 11, wherein, in providing the vehicle movement recommendation service, a third movement determination signal sensed at a point in time when the elapsed parking time reaches the available parking time is collected, the vehicle movement recommendation service is provided when a difference between the second movement determination signal and the third movement determination signal is less than or equal to a preset threshold value, and the third movement determination signal is a signal sensed at a point in time closest to the point in time when the available parking time is reached.

17. The parking management method of claim 16, wherein, in providing the vehicle movement recommendation service, it is determined that the vehicle has moved when the difference between the second movement determination signal and the third movement determination signal is greater than the preset threshold, and the vehicle movement recommendation service is not provided.

18. The parking management method of claim 17, wherein, in providing the vehicle movement recommendation service, the vehicle is woken up and then the vehicle is re-requested to collect the third movement determination signal when the elapsed parking time reaches the available parking time and it is confirmed that the vehicle has entered a sleep mode as a result of the third movement determination signal being requested from the vehicle.

19. The parking management method of claim 11, wherein the vehicle movement recommendation service comprises a notification to the user via a text message or pop-up window.
